(19) United States
(12) Patent Application Publication
(10) Pub. No.: US 2025/0181542 A1
(43) Pub. Date: Jun. 5, 2025

(54) Retimer Module Interconnecting Passive Cables

(71) Applicant: Kandou Labs SA, Saint-Sulpice (CH)

(72) Inventors: Jayarama Shenoy, San Jose, CA (US); Subhash Roy, Lexington, MA (US)

(21) Appl. No.: 18/968,498

(22) Filed: Dec. 4, 2024

Related U.S. Application Data
(60) Provisional application No. 63/606,039, filed on Dec. 4, 2023.

(51) Int. Cl. G06F 13/40; G06F 13/42

(52) U.S. Cl. CPC G06F 13/4068; G06F 13/4221; G06F 2213/0026

(57) ABSTRACT

Methods and systems are described for a retimer module comprising a first cable connector and a second cable connector, a peripheral component interconnect express (PCIe) retimer die comprising one or more upstream PHYs coupled to the first cable connector and one or more downstream PHYs coupled to the second cable connector, the PCIe retimer die further comprising an I²C input coupled between designated I²C pins of the first and second cable connectors, a voltage regulator module (VRM) configured to receive a supply voltage via a pin of the first cable connector, to responsively generate a plurality of regulated supply voltages, and to provide the plurality of regulated supply voltages to the retimer die, and a casing containing the retimer die and the voltage regulator module, the casing comprising a fastener for mounting to a chassis.

### CROSS-REFERENCE TO RELATED APPLICATIONS

This application claims the benefit of U.S. Provisional Patent Application 63/606,039, filed Dec. 4, 2023, naming Jayarama Shenoy and Subhash Roy, entitled “A Retimer Module for Interconnecting Passive Cables” which is herein incorporated by reference in its entirety for all purposes.

### REFERENCES

The following references are herein incorporated by reference in their entirety for all purposes:

PCT Application No US23/79339 filed Nov. 10, 2023, naming Alexander Koch, entitled “Retimer Training and Status State Machine Synchronization Across Multiple Integrated Circuit Dies”, herein [Koch].

### BACKGROUND

Various protocols exist for communicating between different components of a system via a communication link. A common feature of most protocols is that they include a link setup phase in which data is gathered about the communication medium, e.g., a wire in the case of wireline communication or a radio frequency environment in the case of wireless communication. Properties of the link may be set during the link setup phase based on this information gathered about the link and/or based on components communicating via the link, e.g., a root complex and/or endpoint in the case of a PCIe link.

Some protocols provide the option to recalibrate an existing link, perhaps periodically or in response to some state of the link being entered indicating that recalibration is necessary. Data relating to the link can be referred to as link telemetry and the process of gathering information about a link and reporting this information may be called metrology.

In some scenarios it is necessary to include one or more retimers in a communication link in order to ensure that quality-related parameters like bit error rate are met over the entire link. A retimer receives an incoming signal and conditions the signal such that an outgoing signal from the retimer is ‘cleaner’, e.g., it has reduced skew and/or reduced jitter relative to the incoming signal. The data carried by the signal itself is typically unchanged by a retimer. For this reason, a retimer is usually fully transparent to devices communicating via the link. The presence of a retimer splits a link into multiple portions; each portion may have different link telemetry.

Data centers support business applications through e.g, data storage (management, backup, recovery), productivity applications, e-commerce transactions, online gaming, and machine learning/artificial intelligence (AI) based applications. FIG. 1 is a diagram of a data center containing multiple server racks. As shown, the server racks are spaced such that the hot air flows between the backs of adjacent server racks while the cold air flows between the fronts of adjacent server racks. The server racks may contain many rack-mounted chassis that contain motherboards, switch cards, and the like. The motherboards are interconnected by cables. Further, the various boards within a given chassis may be interconnected by e.g., Mini Cool Edge (MCIO) cables.

### BRIEF DESCRIPTION

Methods and systems are described for a retimer module that interfaces to multiple passive MCIO cables to extend the data reach from a host device on a first board to an endpoint device on a second board. The retimer module is mounted on the chassis that contains the first and second boards. The retimer module includes one or more retimer circuit dies that retime data exchanged between the host device and the endpoint device. The retimer module includes a voltage regulator module configured to accept an input voltage from sideband pins of the MCIO interface and to provide a plurality of regulated supply voltages to the retimer circuit die. The retimer module further includes an I²C connection to the MCIO interface. The I²C interface may be used e.g., to configure the retimer circuit die, specifically lane-routing configurations between the upstream and downstream pseudo-ports of the retimer circuit die, as well as to exchange telemetry information gathered from one or more communication protocol layers of the retimer, including the physical (PHY) layer, the data link layer, or higher layers, such as PCIe transaction layers. In some embodiments, the retimer die includes PHY circuits having processors that collect physical layer data and make such metrics available, and the retimer may also have a processor for collecting data from the PHY circuits and from an internal logic analyzer configured to monitor the health of the link. In some embodiments, the retimer module may further include a microcontroller configured to manage the I²C interface in embodiments in which the second board containing the endpoint devices includes a multitude of endpoint devices, e.g., solid-state drives (SSDs).

### BRIEF DESCRIPTION OF THE DRAWINGS

FIG. 1 is a diagram of a data center, in accordance with some embodiments.

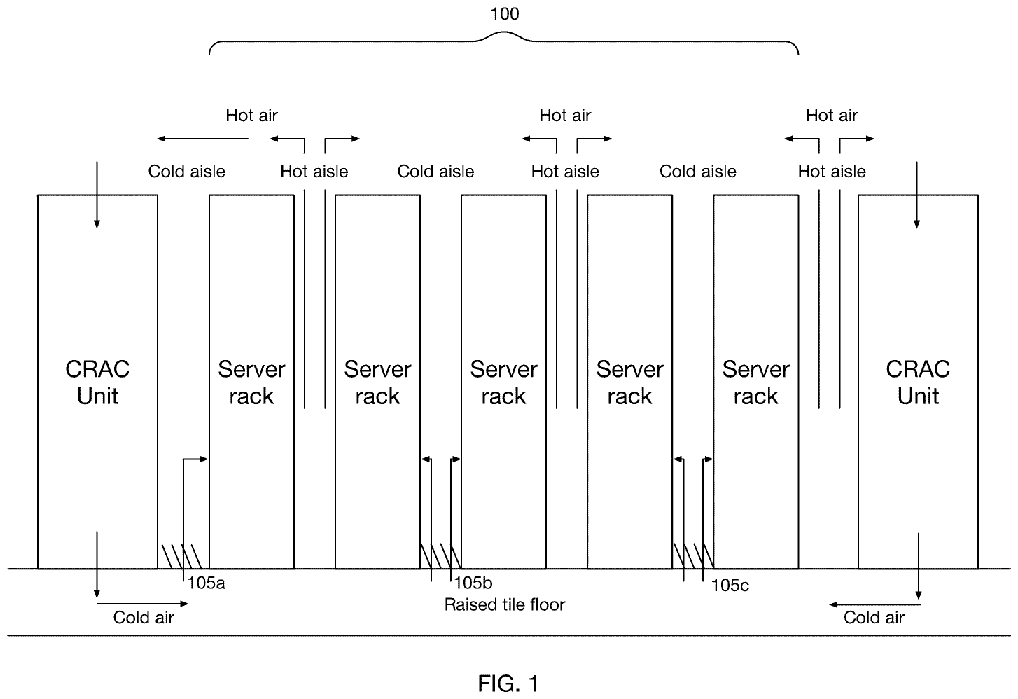

FIG. 2 illustrates an environment of two server racks interconnected by cables, in accordance with some embodiments.

FIG. 3 illustrates a more detailed view of a link between two endpoints on different boards interconnected by an active cable, in accordance with some embodiments.

FIG. 4 is a block diagram of a retimer circuit die, in accordance with some embodiments.

FIG. 5 is a block diagram of a multi-chip module (MCM) including multiple retimer circuit dies configured to exchange state information, in accordance with some embodiments.

FIG. 6 is a block diagram of a host and an endpoint on separate boards interconnected by Mini Cool Edge (MCIO) cables interconnected by a retimer module, in accordance with some embodiments.

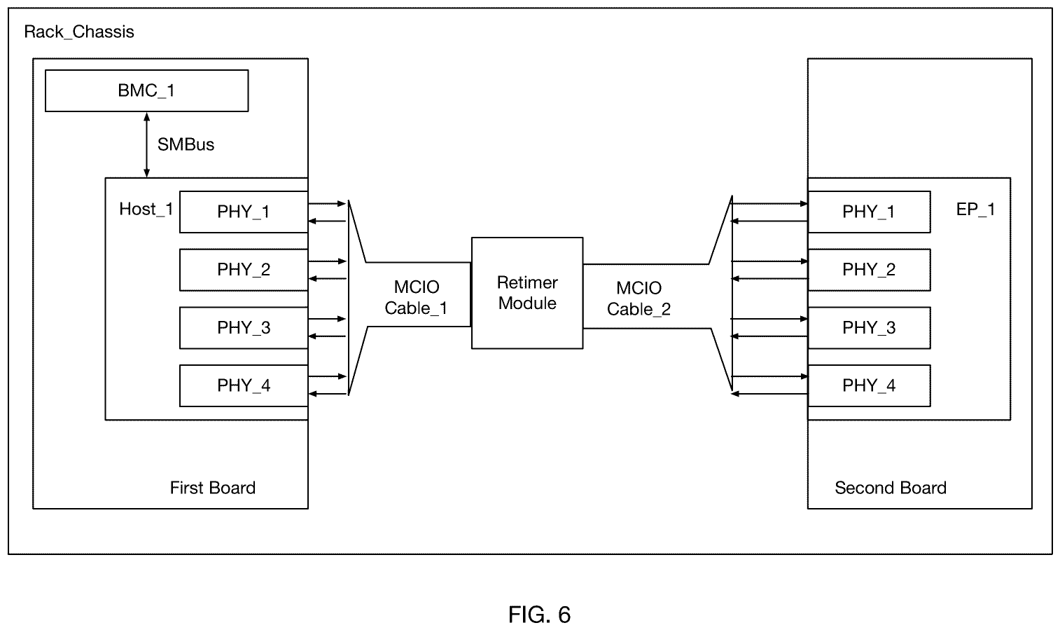

FIG. 7 is a top-down view of a server rack illustrating placement of the retimer module on the side of the chassis, in accordance with some embodiments.

FIG. 8 is a block diagram of a retimer module, in accordance with some embodiments.

FIG. 9 is a pinout diagram of a MCIO cable.

### DETAILED DESCRIPTION

Data centers include multiple server racks that contain many types of printed circuit boards (PCBs) including, but not limited to, central processing unit (CPU) motherboards, graphics processing unit (GPU) motherboards, Input/Output (I/O) boards, and Peripheral Component Interconnect Express (PCIe) switch card boards for e.g., GPUs. Components on PCBs and between PCBs are often connected via MCIO cables which extend PCIe signal paths while maintaining signal integrity (SI) performance compared to conventional PCB routing methods. MCIO connector placements on printed circuit boards (PCBs) are often optimized for trace length on motherboards and PCIe switch boards, and thus often there is no space in the chassis for inserting retimer interposer boards.

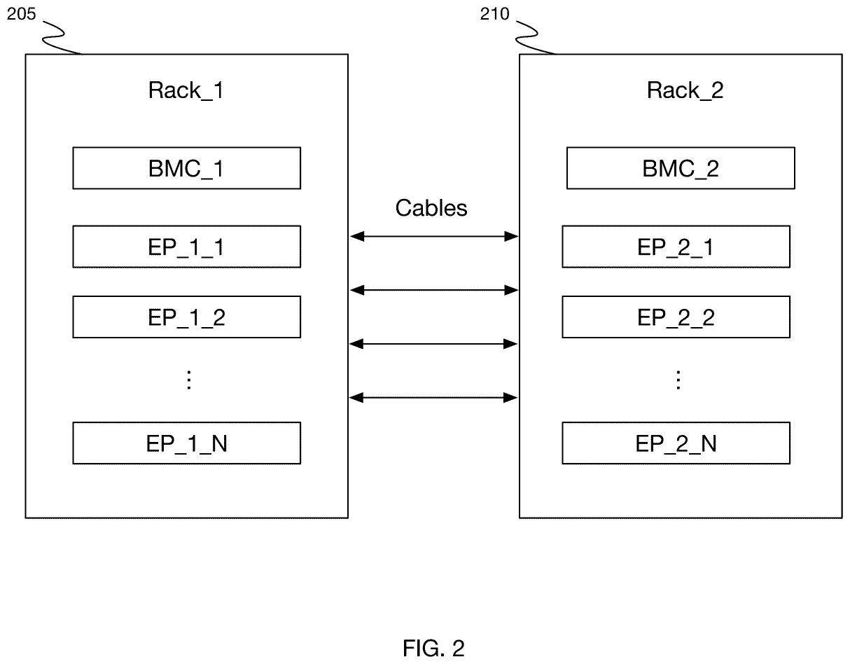

FIG. 2 is a block diagram of two server racks 205 and 210 interconnected via cables. As shown, each server rack 205 and 210 includes a respective board management controller (BMC) as well as a plurality of endpoint devices. In some embodiments, the cables interconnecting the server racks are active cables. An active cable may include retimer devices in each end of the active cable to extend the signal path between two devices operating in e.g., a PCIe link. In some embodiments, the BMC on one server in a server rack may monitor the link health status by gathering telemetry information about each device participating in the link as well as any retimer hops in the link. Embodiments are described herein for an active cable containing retimer circuit dies that include logic analyzers to gather telemetry information, and may provide such telemetry information about circuit dies on two different boards to a BMC on one of the boards.

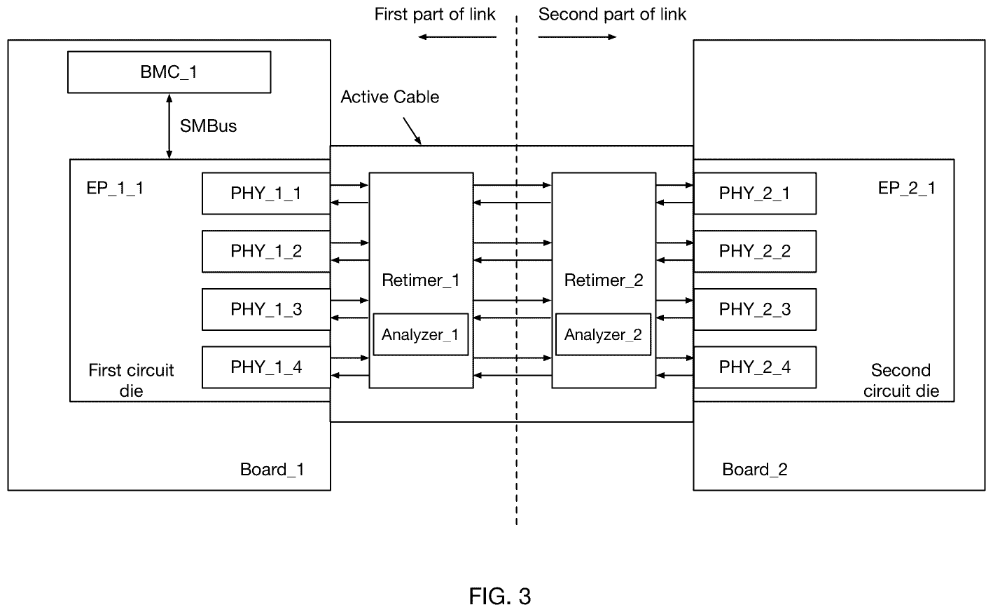

FIG. 3 is a block diagram of two devices EP_1_1 and EP_2_1 interconnected via an active cable. As shown, a four lane PCIe link is established between the two devices, however neither the number of lanes of such a link nor the protocol used should be considered limiting. As shown, each retimer circuit die includes a logic analyzer. The logic analyzer may be configurable to analyze the PHYs of the retimer; both in the upstream and downstream direction. In some embodiments, the PHY circuit may include a processor for configuring and managing the physical layer transceivers, and for performing signal measurements, including eye diagram measurements (eye height, eye width, etc). In some embodiments, the logic analyzer may be configured to perform measurements on one lane at a time. In some embodiments, the logic analyzer may be configured to aggregate measurements of a plurality of lanes. In alternative embodiments, the logic analyzer may be configured to make e.g., eye measurements of the data received at the PHYs of the retimer circuit die. The logic analyzer or retimer processor may be configured to make bit-error rate measurements of the PCIe link. The logic analyzer may be configured to read and output state information of retimer training and status state machines (RTSSMs) configured to manage the core logic of the retimers. In the embodiment of FIG. 3, it may be desired to provide the information gathered by logic analyzer ‘analyzer_2’ in retimer_2 to the BMC_1, which does not have a direct connection via SMBus to retimer_2. In some embodiments, retimer_1 and retimer_2 may communicate with each other in-band using vendor defined messages in control skip ordered sets. In such an embodiment, retimer_1 may request telemetry information from retimer_2 via an in-band message, and retimer_2 may respond with the requested data to retimer_1, which may then provide the data to BMC_1 on board_1.

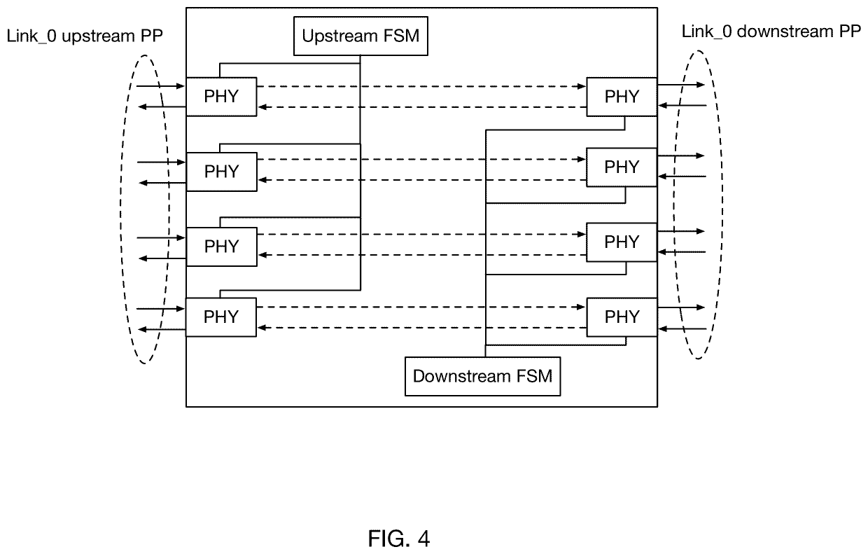

FIG. 4 is a block diagram of a retimer circuit die having upstream and downstream pseudo ports (PPs). As shown, the PHYs in the upstream PP are controlled via an upstream finite state machine (FSM) while the PHYs in the downstream PP are controlled via the downstream FSM. In some embodiments, the retimer circuit die includes respective retimer training and status state machines (RTSSMs) configured to manage each PHY on the retimer. In such an embodiment, the RTSSMs managing the PHYs of a given pseudo-port type are configured to exchange intra-PP state information, while the RTSSMs of two PHYs that make up a lane are each configured to exchange inter-PP state information. Such a retimer circuit die offers highly flexible lane routing capabilities over a retimer including a single FSM to manage the link, however such a constraint should not be considered limiting.

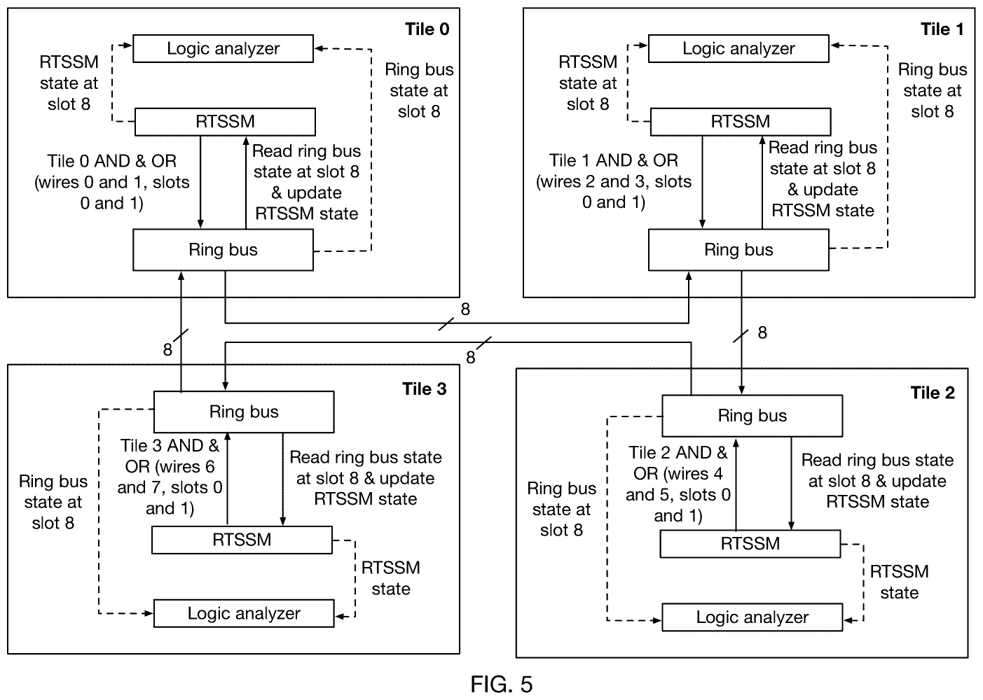

FIG. 5 is a block diagram of a multi-chip module (MCM) including a plurality of retimer circuit dies (i.e., “Tiles”). As shown, each circuit die includes RTSSMs for each PHY as described above. As shown, the MCM includes a ring bus interconnecting the circuit dies to exchange RTSSM status information. The ring bus may be configured to exchange intra-PP status information if PHYs of the same pseudo-port type are distributed across multiple circuit dies. In such a configuration, the RTSSMs of the two PHYs making up each lane are located on the same circuit die and the inter-PP status information may be exchanged directly using an on-die channel. Detail on RTSSM synchronization across multiple tiles may be found in [Koch]. As shown in FIG. 5, the logic analyzer on each circuit die is configurable to read RTSSM status information. As the ring bus has been used to exchange RTSSM status information between circuit dies, upon a complete ring cycle the logic analyzer on any given circuit die has access to RTSSM state information (AND/OR conditions) of every circuit die. In some embodiments, one of the circuit dies is designated as a “leader”. The leader circuit die may be instructed, via e.g., an SMBus connection, to report RTSSM state information. The logic analyzer may log the AND/OR conditions received from each circuit die during the RTSSM synchronization process. In some embodiments, the AND/OR conditions may offer insight as to which circuit die contains the RTSSM that e.g., experienced an interruption, and may thus be useful diagnostic information. Once the problematic circuit die is identified, the logic analyzer on the problematic circuit die may be configured to output more specific state information from RTSSMs on the circuit die to diagnose what led to the problem on the lane of the link.

Additional parameters that may be collected by each retimer and conveyed to a management entity such as a BMC, or relayed to a peer retimer entity for further reporting to a management entity, include, as examples:

| Parameter | Data Type |
|---|---|
| Device UID | String |
| unique port ID | |
| Upstream Link config (Lanes, speed) | Integer, Integer |
| Root complexes maya have a NA entry | |
| Downstream Link config (Lanes, speed) | Integer, Integer |
| End points may have a NA entry | |
| Upstream Link uptime | Time |
| Time since last status change - if applicable | |
| Downstream Link uptime | Time |

Time since last status change—if applicable

Per Lane:

| | |
|---|---|
| Number of correctible errors | Integer |

-Leaky bucket implementation. Time constants are configurable

| | |
|---|---|
| Number of retransmits | Integer |

-Leaky bucket implementation

| | |
|---|---|
| Vertical eye metric | Integer |

-Proxy for link insertion loss (may be PHY dependent)

| | |
|---|---|
| Horizontal eye metric | Integer |

-Proxy for link jitter (may be PHY dependent)

| | |
|---|---|
| Drift in error rate | Integer |

-Derivative of leaky error rate, indicator of change in link health

| | |
|---|---|
| Bathtub floor BER | Integer |

-Estimated

### Retimer Module for Interconnecting Passive Cables

Active cables may also be used between devices within a given chassis of a server rack, however at the cost of some drawbacks. For example, space and power dissipation may continue to be problematic. Further, as the cable length varies between applications and physical configurations of server devices, different length cables are required. Thus, the number of different active cables may grow large, and inventory and product SKU management becomes burdensome. Lastly, adding rigidity to the cable connector restricts overall cable flexibility and may present airflow and heat dissipation issues.

Embodiments are described herein for a retimer module solution that interfaces between two passive MCIO cables to provide retimer functionalities. In some embodiments, the retimer module provides two connectors, one upstream and one downstream, for accepting passive cables to respective upstream and downstream devices. In alternative embodiments, the retimer may be configured to have at least one side, such as the upstream data communication side, hard wired to a fixed cable of a given length terminating in a connector, while the other side of the data connection, e.g., the downstream direction towards an endpoint, may be accessible via connector, such as an MCIO connector, adapted to receive a passive cable. In a further embodiment, the retimer module may be hardwired connected to two fixed passive cables on either side, with each cable having a respective connector for connection to the respective first and second boards. The various embodiments are all characterized by having only a single retimer placed in between the two cable ends, rather than having retimers at each end of an active cable.

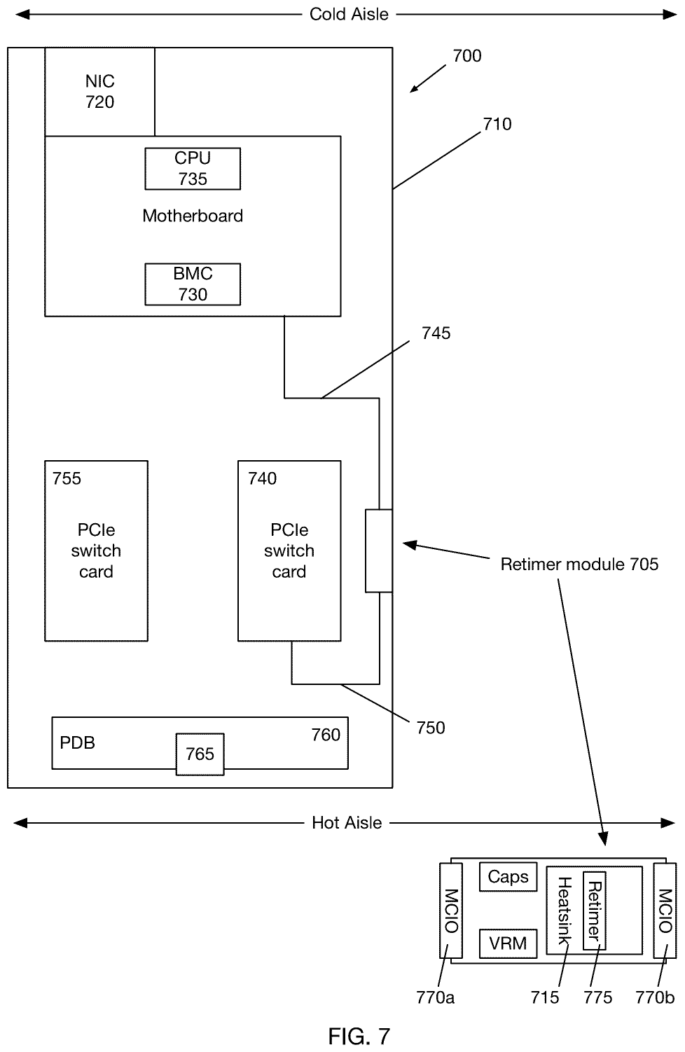

FIG. 7 is a top-down view of a server rack chassis 700, illustrating placement of the retimer module 705. As shown, the retimer module 705 is attached to the chassis wall 710 using a fastener (not shown), e.g., a snap connector or some other kind of fastener, including spring clips or retaining springs, which may be made of metal and exert pressure to hold the retimer module integrated circuit (IC) against the chassis-based heat sink 715. A good thermal interface is created by ensuring firm contact between the IC and the heat sink 715. Thermal Interface Pads (TIPs) may be placed between the IC and the heat sink 715. The TIPS are made of materials with good thermal conductivity and conform to the surfaces, filling any microscopic gaps to enhance heat transfer.

Server rack chassis 700 can also house other components. In the illustrated embodiment a network interface card (NIC) 720 is communicatively coupled to a motherboard 725 that includes a BMC 730 and a CPU 735. A second board 740 is also housed within chassis 1000, the second board 1040 including a PCIe switch card that includes one or more slots/couplings for a component such as a GPU. These components are all purely exemplary and can all be replaced with different components without departing from the scope of this disclosure.

Retimer module 705 facilitates communication between components on motherboard 725 and components on the second board 740. Retimer 705 is coupled to motherboard 725 via a first cable 745 and coupled to the second board 740 via a second cable 750. In the illustrated embodiment both cables are Mini Cool Edge (MCIO) cables but this is not limiting on the scope of this disclosure as any type of cable can be used instead. A link, e.g. a PCIe link, can be established between a component on the motherboard 725, e.g., CPU 735 and a component on the second board 740, e.g., a GPU.

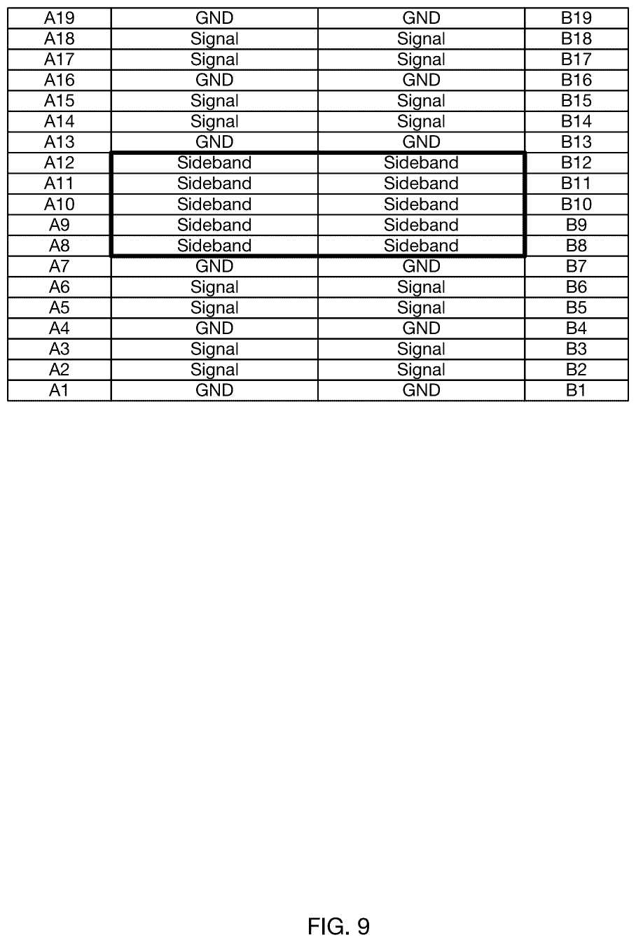

MCIO cables provide a sideband channel—see FIG. 9—and this sideband channel can be used to carry telemetry relating to the end of the link proximate the second board 740 from the second board 740 to the motherboard 725, and specifically to BMC 730. In the case of cables that do not include a sideband channel, in-band channel, e.g., of the type disclosed in [Roy] and discussed above, can be used to transport telemetry from the second board 740 to the motherboard 725. In each case, retimer 775 that is part of retimer module 705 can coordinate the collection and transmission of telemetry in the manner discussed above using the sideband or in-band channel. In both cases, it is thus possible for BMC 730 to obtain telemetry relating to parts of the link that it does not have direct access to, e.g., via a SMBus or other such connection.

It is possible for chassis 700 to include a third board 755. In this case second cable 750 can be a fan out cable that splits into two cables along its length, each of the cables having a respective connector. One of the connectors can be coupled to second board 740 and the other connector coupled to third board 755. The principles discussed above can be applied to each of the cables of second cable 750 so as to enable telemetry to be reported from both second board 740 and third board 755 to BMC 730. This technique can be extended to any number of boards on chassis 700 by increasing the number of cables that fan out of second cable 750.

Thus, with a single retimer module, data connections may be extended using a first passive cable from a first board or assembly to the centrally located retimer module, and a second passive cable from the retimer to the second board or assembly.

Also shown in FIG. 7 is a power distribution board (PDB) 760 including a heatsink 765. The PDB provides power to the various components within chassis 700 via power distribution wires (not shown).

FIG. 7 shows retimer module 705 in more detail in the bottom left of the figure. First and second connectors 770a, 770b, in this case MCIO connectors, are located at opposing ends of retimer module 705 and provide a point of connection for first cable 745 and second cable 750, respectively. Retimer module 705 also includes some capacitors (‘caps’) and a voltage regulator module (VRM). Further details about the VRM are provided below in connection with FIG. 12. Retimer logic 775 is secured to heatsink 715 and is configured to provide retiming functionality for signals received via the first and second connectors 770a, 770b. Retimer logic 775 is also configured to relay telemetry received via a sideband channel or an in-band channel to BMC 730 in the manner discussed above.

The retimer module 705 has a low-profile to reduce air flow restriction. The total cable length between devices is customizable, as two stock cable lengths may be selected in different combinations, thus reducing the number of cable lengths needed to be stocked. The cable length may be customizable in the field. Depending on the available chassis area, multiple retimers may be mounted onto the chassis for multiple links operating at once. The retimer module may be placed on the sides of the server chassis in an area typically reserved for cabling, and may thus attach to the chassis wall or other internal components that may provide a heat sink for heat dissipation.

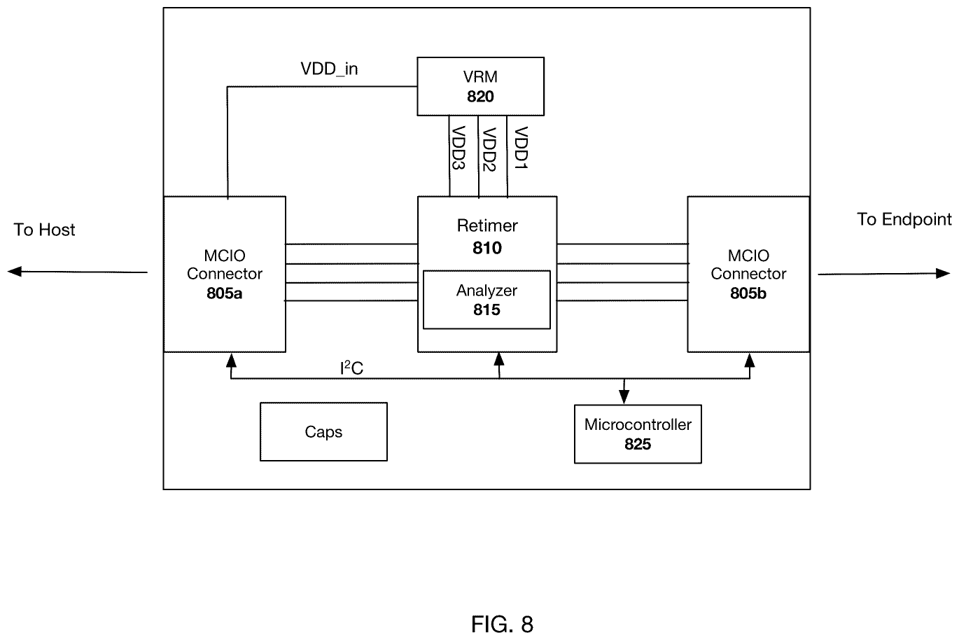

FIG. 8 is a block diagram of a retimer module, in accordance with some embodiments. As shown, the retimer module includes MCIO connectors 805a/805b. The retimer module further comprises a voltage regulator module (VRM) 820 configured to receive a supply voltage from the MCIO connector transferred via the MCIO cable. The supply voltage may be received on e.g., one of the sideband pins shown in FIG. 9. The VRM is configured to supply the retimer 810 with a plurality of regulated supply voltages for e.g., analog circuitry and digital circuitry components.

The retimer module further includes an I²C interface, which may also be interconnected between the host and endpoint using the sideband channels of the MCIO interface. The retimer module further includes a retimer 810. In some embodiments, the retimer 810 may be a single circuit die. In some embodiments, the retimer 810 may include a plurality of homogenous retimer circuit dies. As shown, retimer 810 further includes a logic analyzer 815 configured to monitor health of the passive cable and to provide telemetry information via the I²C bus back to the host. The I²C interface on the retimer 810 may be further utilized for e.g., lane routing configuration. The retimer module may further pass through transactions between the host and endpoint devices on the I²C interface. In some embodiments, the retimer module further includes a microcontroller 825. Microcontroller 825 may be configured to manage the I²C interface to a plurality of downstream devices. Such an application may be e.g., an SSD storage server containing up to as many as 24 individual SSDs.

The retimer 810 includes one or more PHYs of an upstream pseudo-port that interface to MCIO connector 805a. Retimer 810 further includes one or more PHYs of a downstream pseudo-port that interface to MCIO connector 805b. FIG. 8 illustrates a ×4 lane link, however such a width should not be considered limiting. Depending on the total number of PHYs, the retimer 810 may be configured to support a PCIe link having any amount of lanes, including but not limited to ×1, ×2, ×4, ×8, and ×16 lane wide links. In some embodiments, the retimer module may support a plurality of PCIe links simultaneously to different endpoints. For example, in one embodiment, retimer 810 includes 8 total PHYs, and the retimer 810 may support the following configurations:
Four ×1 lane links
One ×2 lane link and two ×1 lane links
Two ×2 lane links
One ×4 lane link

In some embodiments, the retimer 810 may be housed in a package. In some embodiments, other components shown on the retimer module may be included in the package. E.g., the VRM may be included in the package. In alternative embodiments, the retimer 810 may be implemented using a bare die packaging method to reduce the overall are occupied by retimer 810. As shown in FIG. 7, the retimer 810 may be mounted on a heat sink.

FIG. 9 is an illustration of a pinout of the MCIO interface. As shown, the MCIO interface includes a plurality of signal pins, a plurality of ground pins, and a plurality of sideband pins. In some embodiments, the signal pins are mapped via the I2C interface depending on a lane configuration for the PCIe link. As described above, the sideband pins may be utilized to provide the supply voltage (e.g., 12V or 3.3V) to the VRM. Further, the sideband pins may be used to communicate I2C.

In some embodiments, a retimer module includes a first cable connector and a second cable connector, a peripheral component interconnect express (PCIe) retimer die having one or more upstream PHYs coupled to the first cable connector and one or more downstream PHYs coupled to the second cable connector, and an I²C input coupled between designated I²C pins of the first and second cable connectors. The retimer module further includes a voltage regulator module (VRM) configured to receive a supply voltage via a pin of the first cable connector, to responsively generate a plurality of regulated supply voltages, and to provide the plurality of regulated supply voltages to the retimer die and a casing containing the retimer die and the voltage regulator module, the casing comprising a fastener for mounting to a chassis.

In some embodiments, the PCIe retimer die further comprises a logic analyzer. In some embodiments, the logic analyzer is configured to monitor PCIe data link health on the PCIe retimer.

In some embodiments, the first and second cable connectors are Mini Cool Edge (MCIO) cable connectors.

In some embodiments, the PCIe retimer die is mounted to a heat sink on the casing. In some embodiments, the PCIe retimer die is housed in a package. In some embodiments, the VRM is housed in the package as part of a multi-chip module (MCM). In some embodiments, the package comprises a plurality of PCIe retimer dies. In some embodiments, the plurality of PCIe retimer dies are homogonous.

In some embodiments, the retimer module further includes a microcontroller configured to manage I₂C bus communications to a plurality of endpoints.

In some embodiments, the plurality of regulated supply voltages comprises a first regulated supply voltage for analog circuits in the PCIe retimer die and a second regulated supply voltage for digital circuits in the PCIe retimer die. In some embodiments, the VRM is configured to receive a plurality of different supply voltages.

In some embodiments, an apparatus includes a server rack chassis, first and second circuit boards mounted to the server rack chassis, a retimer module as described above mounted to a side wall of the chassis, and first and second cables having respective first connections to the first and second circuit boards, and respective second connections to the first and second cable connectors of the retimer module.

In some embodiments, an apparatus includes a first circuit die includes at least one local Physical Layer circuit (PHY) configured to be associated with a first part of a link and configured to provide physical-level link metrology data relating to the first part of the link, the at least one local PHY configured to be communicatively coupled to a first end of a cable and a board management controller (BMC) configured to receive the physical-level link metrology data relating to the first part of the link from the at least one local PHY, and further configured to receive physical-level link metrology data relating to a second part of the link from at least one remote PHY that is coupled to a second end of the cable via an in-band channel.

In some embodiments, the apparatus further includes a local retimer coupled in the first part of the link, the retimer comprising a logic analyzer configured to provide logical-level link metrology data relating to the first part of the link, and the BMC is further configured to receive the logical-level link metrology data relating to the first part of the link from the local retimer.

In some embodiments, the BMC is further configured to receive, via the in-band channel, logical-level link metrology data relating to the second part of the link from a remote logic analyzer that is part of a remote retimer coupled in the second part of the link.

In some embodiments, the local retimer is configured to be located within the first end of the cable.

In some embodiments, the link is a PCIe link and the in-band channel is a PCIe vendor-defined message channel. In some embodiments, the PCIe vendor-defined message channel carries metrology data within control skip ordered sets.

In some embodiments, the physical-level link metrology data includes any one of more of: a lane identifier of the respective lane, a lane speed of the respective lane, an upstream uptime of the link, a downstream uptime of the link, an upstream configuration of the link, a downstream configuration of the link, a number of correctible errors of the respective lane, a number of retransmits of the respective lane, a vertical eye metric of the respective lane, a horizontal eye metric of the respective lane, a drift in error rate of the respective lane, and a bathtub floor bit error rate of the respective lane.

In some embodiments, a system includes a first circuit die having a board management controller (BMC) and at least one local PHY, the at least one local PHY being logically located in a first part of a link and configured to provide physical-level link metrology data relating to the first part of the link to the BMC, a second circuit die having at least one remote PHY, the at least one remote PHY being logically located in a second part of the link and configured to provide physical-level link metrology data relating to the second part of the link to the BMC using an in-band channel supported by the link, and a cable coupled between the at least one local PHY and the at least one remote PHY to enable communication between the first circuit die and the second circuit die via the link. In some embodiments, the cable further includes a first retimer comprising a first logic analyzer, the first retimer coupled to the at least one local PHY via the link and logically located in the first part of the link, the first logic analyzer configured to provide logical-level link metrology data relating to the first part of the link to the BMC via the in-band channel. The cable may further include a second retimer having a second logic analyzer, the second retimer coupled to the at least one remote PHY via the link and logically located in the second part of the link, the second logic analyzer configured to provide logical-level link metrology data relating to the second part of the link to the BMC via the in-band channel.

1. A retimer module comprising:
a first cable connector and a second cable connector;
a peripheral component interconnect express (PCIe) retimer die comprising one or more upstream PHYs coupled to the first cable connector and one or more downstream PHYs coupled to the second cable connector, the PCIe retimer die further comprising an I²C input coupled between designated I²C pins of the first and second cable connectors;
a voltage regulator module (VRM) configured to receive a supply voltage via a pin of the first cable connector, to responsively generate a plurality of regulated supply voltages, and to provide the plurality of regulated supply voltages to the retimer die; and
a casing containing the retimer die and the voltage regulator module, the casing comprising a fastener for mounting to a chassis.

2. The retimer module of claim 1, wherein the PCIe retimer die further comprises a logic analyzer.

3. The retimer module of claim 2, wherein the logic analyzer is configured to monitor PCIe data link health on the PCIe retimer.

4. The retimer module of claim 1, wherein the first and second cable connectors are Mini Cool Edge (MCIO) cable connectors.

5. The retimer module of claim 1, wherein the PCIe retimer die is mounted to a heat sink on the casing.

6. The retimer module of claim 1, wherein the PCIe retimer die is housed in a package.

7. The retimer module of claim 6, wherein the VRM is housed in the package as part of a multi-chip module (MCM).

8. The retimer module of claim 6, wherein the package comprises a plurality of PCIe retimer dies.

9. The retimer module of claim 8, wherein the plurality of PCIe retimer dies are homogonous.

10. The retimer module of claim 1, further comprising a microcontroller configured to manage I₂C bus communications to a plurality of endpoints.

11. The retimer module of claim 1, wherein the plurality of regulated supply voltages comprises a first regulated supply voltage for analog circuits in the PCIe retimer die and a second regulated supply voltage for digital circuits in the PCIe retimer die.

12. The retimer module of claim 1, wherein the VRM is compatible to receive a plurality of different supply voltages.

13. An apparatus comprising:
A server rack chassis;
first and second circuit boards mounted to the server rack chassis;
a retimer module mounted to a side wall of the chassis, the retimer module comprising:
a first cable connector and a second cable connector;
a peripheral component interconnect express (PCIe) retimer die comprising one or more upstream PHYs coupled to the first cable connector and one or more downstream PHYs coupled to the second cable connector, the PCIe retimer die further comprising an I²C input coupled between designated I²C pins of the first and second cable connectors;
a voltage regulator module (VRM) configured to receive a supply voltage via a pin of the first cable connector, to responsively generate a plurality of regulated supply voltages, and to provide the plurality of regulated supply voltages to the retimer die; and
a casing containing the retimer die and the voltage regulator module, the casing comprising a fastener for mounting to the server rack chassis; and
first and second cables having respective first connections to the first and second circuit boards, and respective second connections to the first and second cable connectors of the retimer module.

14. An apparatus, comprising:
a first circuit die comprising:
at least one local Physical Layer circuit (PHY) configured to be associated with a first part of a link and configured to provide physical-level link metrology data relating to the first part of the link, the at least one local PHY configured to be communicatively coupled to a first end of a cable; and
a board management controller (BMC) configured to receive the physical-level link metrology data relating to the first part of the link from the at least one local PHY, and further configured to receive physical-level link metrology data relating to a second part of the link from at least one remote PHY that is coupled to a second end of the cable via an in-band channel.

15. The apparatus of claim 14, further comprising:
a local retimer coupled in the first part of the link, the retimer comprising a logic analyzer configured to provide logical-level link metrology data relating to the first part of the link;
wherein the BMC is further configured to receive the logical-level link metrology data relating to the first part of the link from the local retimer.

16. The apparatus of claim 14, wherein the BMC is further configured to receive, via the in-band channel, logical-level link metrology data relating to the second part of the link from a remote logic analyzer that is part of a remote retimer coupled in the second part of the link.

17. The apparatus of claim 14, wherein the local retimer is configured to be located within the first end of the cable.

18. The apparatus of claim 14, wherein the link is a PCIe link and the in-band channel is a PCIe vendor-defined message channel.

19. The apparatus of claim 18, wherein the PCIe vendor-defined message channel carries metrology data within control skip ordered sets.

20. The apparatus of claim 14, wherein the physical-level link metrology data includes any one of more of: a lane identifier of the respective lane, a lane speed of the respective lane, an upstream uptime of the link, a downstream uptime of the link, an upstream configuration of the link, a downstream configuration of the link, a number of correctible errors of the respective lane, a number of retransmits of the respective lane, a vertical eye metric of the respective lane, a horizontal eye metric of the respective lane, a drift in error rate of the respective lane, and a bathtub floor bit error rate of the respective lane.
